(19) United States
(12) Patent Application Publication
(10) Pub. No.: US 2009/0082242 A1
(43) Pub. Date: Mar. 26, 2009

(54) DISHWASHING METHOD

(76) Inventors: Anju Deepali Massey Brooker, Newcastle/Tyne (GB); Alberto Martinez-Becares, Newcastle upon Tyne (GB); David William York, Newcastle upon Tyne (GB); Dan Xu, Newcastle/Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/211,968

(22) Filed: Sep. 17, 2008

(30) Foreign Application Priority Data
Sep. 24, 2007 (EP) 07117087.2

(51) Int. Cl. C11D 3/02

(52) U.S. Cl. 510/220

(57) ABSTRACT

A method of cleaning a soiled load in an automatic dishwasher comprising the step of contacting the load with a phosphate free wash liquor comprising exfoliated nanoclay, the liquor having a pH of from about 9 to about 12 and an ionic strength of from about 0.001 to about 0.02 moles/l.

### TECHNICAL FIELD

The present invention is in the field of cleaning, in particular it relates to automatic dishwashing, especially to automatic dishwashing methods, compositions and products comprising nanoclay.

### BACKGROUND OF THE INVENTION

In the field of automatic dishwashing the formulator is constantly looking for improved cleaning methods, having a more environmentally friendly profile and being more effective than current methods.

U.S. Pat. No. 4,597,886 relates to an enzymatic dishwashing composition comprising an effective level of a layered clay. Filming and spotting on the cleaned objects is significantly reduced. The present invention concerns the removal of soil from dishware/tableware rather than filming and spotting of the washed items.

### SUMMARY OF THE INVENTION

According to a first aspect of the present invention, there is provided a method of cleaning a soiled load (i.e., soiled housewares such as pots, pans, dished, cups, saucers, bottles, glassware, crockery, kitchen utensils, etc) in an automatic dishwasher, the method comprises the step of contacting the load with a phosphate free wash liquor, the wash liquor comprising exfoliated nanoclay. The method of the invention is especially effective for the removal of starch based soils from dishware/tableware.

Nanoclays are charged crystals having a layered structure. The top and bottom of the crystals are usually negatively charged and the sides are positively charged. Due to the charged nature of nanoclays, they tend to aggregate in solution to form large structures that do not effectively contribute to the cleaning. Moreover, these structures may deposit on the washed load leaving an undesirable film on them. In particular the nanoclays tend to aggregate in the presence of calcium and magnesium found in the wash water. A key requirement of the method of the invention is the nanoclay to be exfoliated in the wash liquor. By “exfoliated nanoclay” is meant that the nanoclay is in the form of independent crystals, in particular in the form of individual crystals having a particle size of from about 10 nm to about 300 nm, preferably from about 20 nm to about 100 nm and especially form about 30 to about 90 nm. The particle size of the crystals can be measured using a Malvern zetasizer instrument. The nanoclay particle size referred to herein is the z-average diameter, an intensity mean size.

In order to achieve good cleaning the wash liquor containing the nanoclay should have a high pH and a low ionic strength. Without being bound by theory, it is believed that the high pH contributes to the hydration of the nanoclay and the low ionic strength contributes to the dispersion of the nanoclay. The combination of high pH and low ionic strength contributes to maintain the nanoclay in exfoliated form, avoiding aggregation.

Preferably the wash liquor has a pH of from about 9 to about 12, more preferably from about 10 to about 11.5 and an ionic strength of from about 0.001 to about 0.02, more preferably from about 0.002 to about 0.015, especially from about 0.005 to about 0.01 moles/l. The method provides excellent cleaning, in particular on starch containing soils. Heavily soiled items such as those containing burn-on, baked-on or cook-on starchy food such as pasta, rice, potatoes, wholemeal, sauces thickened by means of starchy thickeners, etc. are easily cleaned using the method of the invention.

By phosphate free wash liquor is understood a wash liquor having a phosphate content of less than about 10%, preferably less than about 5% and more preferably less than 1% by weight of the wash solution. Because phosphates are believed to adversely impact the environment, there has been a continuing effort to decrease phosphate use in detergent compositions and to provide phosphate-free dishwashing detergents.

The nanoclay used in the present invention has a particle size in the wash liquor of from about 10 to about 200 nm, preferably from about 20 to about 100 nm and especially from about 30 to about 80 nm. Regarding shape, the nanoclay of the invention may have any shape but preferred herein are nanoclays with disc-shape (i.e., flat circular shape). Without being bound by theory it is believed that the nanoclay cleans by penetrating the interface between the soiled substrate and the soil. Nanoclay having a disc-shape is believed to penetrate more easily the interface and contribute to a more effective cleaning.

The nanoclay used herein may be either naturally occurring (milled to the appropriate size if required) or synthetic. Preferred nanoclays for use in the present invention are natural or synthetic hectorites, montmorillonites and bentonites, and of these synthetic hectorites are especially preferred. Preferred for use herein is a synthetic hectorite commercially available under the name Laponite® RD. Wash liquors containing nanoclay, especially synthetic hectorite, have been found better for cleaning than wash liquors containing other nanoparticles.

The method of the invention allows for the use of a wide range of nanoclay concentrations. The concentration of nanoclay in the wash liquor is preferably from about 100 ppm to about 2,500 ppm, more preferably from about 200 to about 2,000 and especially from about 300 to about 1,000 ppm.

The wash liquor comprises an alkalinity source in an amount sufficient to give the wash liquor the desired pH. Preferably the wash liquor contains from about 20 to about 1,200 ppm, more preferably from about 100 to about 1,000 of an alkalinity source. It is especially preferred that the alkalinity source comprises a source of univalent ions. Univalent ions contribute to high alkalinity and at the same time hardly raise the ionic strength of the wash solution. Preferred alkalinity sources for use herein are metal hydroxides, in particular sodium or potassium hydroxide and especially potassium hydroxide.

In preferred embodiments the wash liquor further comprises a nanoclay dispersant. The dispersant helps to keep the nanoparticle exfoliated, especially under hard water conditions (hardness level greater than about 200 ppm (as CaCO₃)). Nanoclay dispersant is a compound capable of keeping the nanoclay dispersed in a solution having a pH of from about 9 to about 12, having an ionic strength of from about 0.01 to about 0.02 moles/l and containing at least 96 ppm of Ca2+, preferably at least 191 ppm of Ca2+ and more preferably at least 219 ppm of Ca2+. Whether the nanoclay is exfoliated or aggregated can be determined by measuring the particle size of the nanoclay crystals in the solution. Preferably the nanoclay and the dispersant are in a weight ratio of from about 1:1 to about 1:10, preferably from about 1:2 to about 1:8. Flocculation or aggregation has been found to occur outside these ranges.

A preferred dispersant for use herein is a low molecular weight polyacrylate homopolymer, having a molecular weight of from about 1,000 to about 30,000, preferably from about 2,000 to about 20,000 and more preferably from about 3,000 to about 12,000. This kind of polymer is a particularly good nanoclay dispersant. Another preferred dispersant for use herein is an aminocarboxylate chelant, in particular MGDA (methyl glycine di-acetic acid) and GLDA (glutamic acid-N,N-diacetate).

In other preferred embodiments the dispersant is a mixture of a low molecular weight polyacrlyate homopolymer and a chelant, in particular an amino polycarboxylate chelant. It has been found that the combination of low molecular weight polyacrylates with amino polycarboxylate chelants is good not only in terms of keeping the nanoclay exfoliated but also in terms of soil removal. MGDA and GLDA have been found most suitable amino polycarboxylate chelants for use herein.

Methods in which the wash liquor has a high concentration of nanoclay produce excellent cleaning results, particularly starch cleaning, even in the absence of other cleaning actives or with the help of a small amount of other cleaning actives.

Methods in which the wash liquor comprises a low concentration of nanoclay and enzymes produce excellent cleaning results, even under cold conditions, i.e., below 60° C., preferably below 50° C. and especially below 40° C. There is a synergy, in terms of cleaning, when the wash liquor comprises low level of nanoparticle and enzymes, in particular amylases. Thus, in preferred embodiments the wash liquor comprises from about 200 to about 600 ppm, preferably from about 300 to about 500 ppm of nanoclay and from about 10 to about 200 ppm, preferably from about 0.01 to about 20 ppm of active enzyme. Preferred enzyme for use herein includes proteases and amylases and especially combinations thereof.

The nanoclay can negatively interact with some enzymes, in particular with proteases. In preferred embodiments of the method of the invention, there is a delayed release of the nanoclay with respect to the enzyme. This ameliorates the negative interaction. By “delayed release” is meant that at least 50%, preferably at least 60% and more preferably at least 80% of one of the components is delivered into the wash solution at least one minute, preferably at least two minutes and more preferably at least 3 minutes, than at less than 50%, preferably less than 40% of the other component. The nanoparticle can be delivered first and the enzyme second or vice-versa. Good cleaning results are obtained when the enzyme, in particular protease, is delivered first and the nanoclay second. Delayed release can be achieved by for example using a multi-compartment pouch wherein different compartments have different dissolution rates, by having multi-phase tablets where different phases dissolve at different rates, having coated bodies, etc.

According to a second embodiment of the invention, there is provided a phosphate free composition comprising an exfoliable nanoclay (i.e., a nanoparticle which is in exfoliated form in the wash liquor). The composition provides a wash pH of from about 9 to about 12, preferably from about 10 to about 11.5 and an ionic strength of from about 0.001 to about 0.02, preferably from about 0.002 to about 0.015, more preferably form about 0.005 to about 0.01 moles/l. Preferably the composition is suitable for use in the method of the invention.

It is also preferred that the composition comprises from about 2 to about 60%, more preferably from 5 to 50% by weight thereof of exfoliable nanoclay. Preferably the composition comprises an alkalinity source in a level of from about 1 to about 40%, more preferably from about 5 to about 35% by weigh of the composition. Preferably, the composition comprises a source of univalent ions, in particular sodium or potassium hydroxide. Also preferred are compositions free of compounds which form insoluble calcium or magnesium salt, such as carbonates and silicates. Preferably the composition comprises a nanoclay dispersant in a level of from about 10 to about 60%, preferably from about 20 to 50% by weigh of the composition.

The compositions of the invention can be in any physical form, solid, liquid, gel, etc. Preferred for use herein are compositions in solid form, for example powder, either loose powder or compressed powder.

In another aspect of the invention, there is provided a water-soluble pouch, preferably a multi-compartment pouch. Multi-compartment pouches allows for separation of incompatible ingredients and for differential and delayed release of different ingredients.

### DETAILED DESCRIPTION

The present invention envisages a method of automatic dishwashing in a dishwasher wherein the wash liquor comprises exfoliated nanoclay, the invention also envisages composition comprising exfoliable nanoclay. The method and composition provide excellent removal of tough food soils from cookware and tableware, in particular starchy soils. Excellent results have been achieved when the dishwashing liquor comprises nanoclay as main soil removal active, either in absence of or in combination with other cleaning actives (such as enzymes, builders, surfactants, etc). This obviates or reduces the use of traditional dishwashing detergents. The compositions are free of phosphate builders.

A composition that has been found to give excellent results comprises from about 2 to 60%, preferably from 5 to 50% by weight of the composition of nanoclay, from about 1 to about 40%, preferably from about 5 to about 35% by weight of the composition of an alkalinity source, from about 10 to about 60%, preferably from about 20 to about 50% by weight of the composition of a nanoclay dispersant, from about 5 to about 40%, preferably from about 10 to about 30% by weight of the composition of bleach and from about 0.5 to about 10%, preferably from about 0.01 to about 2% by weight of the composition of active enzyme.

### Nanoclay

The nanoclay suitable for use herein has a particle size (z-average diameter) of from about 10 nm to about 300 nm, preferably from about 20 nm to about 100 nm and especially form about 30 to about 90 nm.

The layered clay minerals suitable for use in the present invention include those in the geological classes of the smectites, the kaolins, the illites, the chlorites, the attapulgites and the mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite.

The nanoclay of the present invention may be either naturally occurring or synthetic. Some embodiments of the present invention may use natural or synthetic hectorites, montmorillonites and bentonites. Especially preferred are synthetic hectorites clays. Typical sources of commercial hectorites are the LAPONITES from Rockwood Additives Limited or Southern Clay Products, Inc., U.S.A.; Veegum Pro and Veegum F from R. T. Vanderbilt, U.S.A.; and the Barasyms, Macaloids and Propaloids from Baroid Division, National Read Comp., U.S.A.

### Natural Clays

Natural clay minerals typically exist as layered silicate minerals and less frequently as amorphous minerals. A layered silicate mineral has SiO4 tetrahedral sheets arranged into a two-dimensional network structure. A 2:1 type layered silicate mineral has a laminated structure of several to several tens of silicate sheets having a three layered structure in which a magnesium octahedral sheet or an aluminium octahedral sheet is sandwiched between two sheets of silica tetrahedral sheets.

A sheet of an expandable layer silicate has a negative electric charge, and the electric charge may be neutralized by the existence of alkali metal cations and/or alkaline earth metal cations.

### Synthetic Clays

With appropriate process control, the processes for the production of synthetic nanoscale powders (i.e. synthetic clays) does indeed yield primary particles, which are nanoscale. The production of nanoscale powders such as layered hydrous silicate, layered hydrous aluminium silicate, fluorosilicate, mica-montmorillonite, hydrotalcite, lithium magnesium silicate and lithium magnesium fluorosilicate are common

Synthetic hectorite was first synthesized in the early 1960's and is now commercially marketed under the trade name LAPONITE by Rockwood Additives Limited and Southern Clay Products, Inc. There are many grades or variants and isomorphous substitutions of LAPONITE marketed. Examples of commercial hectorites are Lucentite SWN, LAPONITE S, LAPONITE XLS, LAPONITE RD and LAPONITE RDS. Preferred for use herein is Laponite RD.

The ratio of the largest dimension of a particle to the smallest dimension of a particle is known as the particle's aspect ratio. The aspect ratio of the particles in a dispersed medium can be considered to be lower where several of the particles are aggregated than in the case of individual particles. The aspect ratio of dispersions can be adequately characterized by TEM (transmission electron microscopy). A high aspect ratio is desirable for the nanoclay for use herein. Preferably the aspect ratio of the nanoclay in the wash liquor is from 5 to about 35, preferably from about 10 to about 20.

### Ionic Strength

Preferably the wash liquor has an ionic strength of from about 0.001 to about 0.02, more preferably from about 0.002 to about 0.015, especially form about 0.005 to about 0.01 moles/l.

Ionic strength is calculated from the molarity (m) of each ionic species present in solution and the charge (z) carried by each ionic species. Ionic strength (I) is one half the summation of m.z² for all ionic species present i.e.

I=½Σm.z²

For a salt whose ions are both univalent, ionic strength is the same as the molar concentration. This is not so where more than two ions or multiple charges are involved. For instance a 1 molar solution of sodium carbonate contains 2 moles/litre of sodium ions and 1 mole/litre of carbonate ions carrying a double charge. Ionic strength is given by:

I=½[2(1²)+1×(2²)]=3 moles/litre

### Alkalinity Source

Examples of alkalinity source include, but are not limited to, an alkali hydroxide, alkali hydride, alkali oxide, alkali sesquicarbonate, alkali carbonate, alkali borate, alkali salt of mineral acid, alkali amine, alkaloid and mixtures thereof. Sodium carbonate, sodium and potassium hydroxide are preferred alkalinity sources for use herein, in particular potassium hydroxide. The alkalinity source is present in an amount sufficient to give the wash liquor a pH of from about 9 to about 12, more preferably from about 10 to about 11.5.

### Chelant

Suitable chelant (also herein referred to as chelating agent) to be used herein may be any chelating agent known to those skilled in the art such as the ones selected from the group comprising phosphonate chelating agents, amino carboxylate chelating agents or other carboxylate chelating agents, or polyfunctionally-substituted aromatic chelating agents or mixtures thereof.

Such phosphonate chelating agents may include etidronic acid (1-hydroxyethylidene-bisphosphonic acid or HEDP) as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

Suitable amino carboxylate chelating agents useful herein include nitrilotriacetates (NTA), ethylene diamine tetra acetate (EDTA), diethylene triamine pentacetate (DTPA), N-hydroxyethylethylenediamine triacetate, nitrilotri-acetate, ethylenediamine tetraproprionate, triethylenetetraaminehexa-acetate (HEDTA), triethylenetetraminehexaacetic acid (TTHA), propylene diamine tetracetic acid (PDTA) and, both in their acid form, or in their alkali metal salt forms. Particularly suitable to be used herein are diethylene triamine penta acetic acid (DTPA) and propylene diamine tetracetic acid (PDTA). A wide range of aminocarboxylate chelating agents is commercially available from BASF under the trade name Trilon®. A preferred biodegradable amino carboxylate chelating agent for use herein is ethylene diamine N,N′-disuccinic acid (EDDS), or alkali metal or alkaline earth salts thereof or mixtures thereof. Ethylenediamine N,N′-disuccinic acids, especially the (S,S) isomer have been extensively described in U.S. Pat. No. 4,704,233, Nov. 3, 1987 to Hartman and Perkins. Ethylenediamine N,N′-disuccinic acid is, for instance, commercially available under the tradename ssEDDS® from Palmer Research Laboratories.

Aminodicarboxylic acid-N,N-dialkanoic acid or its salt are also suitable amino carboxylate chelanting agents for use herein. The compounds can be represented by the following formula:

MOOC—CHZ¹—NZ²Z³

wherein each of Z¹, Z² and Z³ independently represents a COOM-containing group; wherein each of M independently represents either of a hydrogen atom, sodium, potassium or amine ion.

In the above formula, Z¹, Z² and Z³ may either be same with or different from each other, and examples of those groups are found among carboxymethyl group, 1-carboxyethyl group, 2-carboxyethyl group, 3-carboxypropan-2-yl group, their salts, etc. As concrete examples, there are glutamic acid-N,N-diacetic acid, glutamic acid-N,N-dipropionic acid, and their salts. Above all, glutamic acid-N,N-diacetate is especially preferred, in particular L-glutamic acid-N,N-diacetate.

Other suitable chelating agents include ethanoldiglycine and methyl glycine di-acetic acid (MGDA).

Further carboxylate chelating agents useful herein include low molecular weight hydrocarboxylic acids, such as citric acid, tartaric acid malic acid, lactic acid, gluconic acid, malonic acid, salicylic acid, aspartic acid, glutamic acid, dipicolinic acid and derivatives thereof, or mixtures thereof.

### Polymer

Suitable polymers acting as nanoclay dispersant include polymeric polycarboxylated polymers, including homopolymers and copolymers. Preferred for use herein are low molecular weight (from about 2,000 to about 30,000, preferably from about 3,000 to about 20,000) homopolymers of acrylic acid. They are commercially available from BASF under the Sokalan PA range. An especially preferred material is Sokalan PA 30. Sodium polyacrylate having a nominal molecular weight of about 4,500, is obtainable from Rohm & Haas under the tradename ACUSOL® 445N. Other polymeric polycarboxylated polymers suitable for use herein include copolymers of acrylic acid and maleic acid, such as those available from BASF under the name of Sokalan CP and AQUALIC® ML9 copolymers (supplied by Nippon Shokubai Co. LTD).

Other suitable polymer dispersants for use herein are polymers containing both carboxylate and sulphonate monomers, such as ALCOSPERSE® polymers (supplied by Alco) and Acusol 588 (supplied by Rohm&Hass).

Polyethylene imine polymers are also useful in the method of the invention. This kind of polymer is available from BASF under the Lupasol tradename.

With reference to the polymers described herein, the term weight-average molecular weight (also referred to as molecular weight) is the weight-average molecular weight as determined using gel permeation chromatography according to the protocol found in Colloids and Surfaces A. Physico Chemical & Engineering Aspects, Vol. 162, 2000, pg. 107-121. The units are Daltons.

### Cleaning Actives

Any traditional cleaning ingredients can be used in the method, composition and product of the invention.

### Bleach

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 1 9, and most preferably from 1:49 to 1:19. Preferably, the mixed salt is of sodium sulphate and sodium carbonate which has the general formula Na2S04.n.Na2CO3 wherein n is from 0.1 to 3, preferably n is from 0.3 to 1.0 and most preferably n is from 0.2 to 0.5.

Another suitable coating material providing in product stability, comprises sodium silicate of Si02: Na20 ratio from 1.8:1 to 3.0:1, preferably L8:1 to 2.4:1, and/or sodium metasilicate, preferably applied at a level of from 2% to 10%, (normally from 3% to 5%) Of Si02 by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein.

The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns.

Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

### Bleach Catalyst

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the composition.

### Surfactant

Preferably the compositions (methods and products) for use herein are free of surfactants. A preferred surfactant for use herein is low foaming by itself or in combination with other components (i.e. suds suppressers). Preferred for use herein are low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678 , U.S. Pat. No. 4,259,217, EP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of a detergent composition. Preferred surfactant for use herein, if any, are low foaming and include low cloud point nonionic surfactants and mixtures of higher foaming surfactants with low cloud point nonionic surfactants which act as suds suppresser therefor.

### Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 Lipase^{R} and Lipomax^{R} (Gist-Brocades) and Lipolase^{R} and Lipolase Ultra^{R} (Novo); cutinases; proteases such as Esperase^{R}, Alcalase^{R}, Durazym^{R} and Savinase^{R} (Novo) and Maxatase^{R}, Maxacal^{R}, Properase^{R} and Maxapem^{R} (Gist-Brocades); and amylases such as Purafect Ox Am^{R} (Genencor) and Termamyl^{R}, Ban^{R}, Fungamyl^{R}, Duramyl^{R}, and Natalase^{R}(Novo); pectinases; and mixtures thereof. Enzymes are preferably added herein as prills, granulates, or cogranulates at levels typically in the range from about 0.0001% to about 5%, more preferably from about 0.001% to about 2% pure enzyme by weight of the cleaning composition. Preferred for use herein are proteases, amylases and in particular combinations thereof.

### Low Cloud Point Non-Ionic Surfactants and Suds Suppressers

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., BASF Poly-Tergent® SLF18) and epoxy-capped poly(oxyalkylated) alcohols (e.g., BASF Poly-Tergent® SLF18B series of nonionics, as described, for example, in U.S. Pat. No. 5,576,281).

Preferred low cloud point surfactants are the ether-capped poly(oxyalkylated) suds suppresser having the formula:

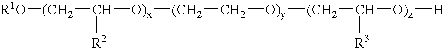

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

### Water-Soluble Pouch

In a preferred embodiment of the present invention the detergent composition is in the form of a water-soluble pouch, more preferably a multi-phase unit dose pouch, preferably an injection-moulded, vacuum- or thermoformed multi-compartment, wherein at least one of the phases comprises the nanoclay. Preferred manufacturing methods for unit dose executions are described in WO 02/42408 and EP 1,447,343 B1. Any water-soluble film-forming polymer which is compatible with the compositions of the invention and which allows the delivery of the composition into the main-wash cycle of a dishwasher can be used as enveloping material.

Most preferred pouch materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

### Delayed Release

Delayed release can be achieved by means of coating, either by coating active materials or particle containing active material. The coating can be temperature, pH or ionic strength sensitive. For example particles with a core comprising either nanoclay or enzyme and a waxy coating encapsulating the core are adequate to provide delayed release. For waxy coating see WO 95/29982. pH controlled release means are described in WO 04/111178, in particular amino-acetylated polysaccharide having selective degree of acetylation.

Other means of obtaining delayed release are pouches with different compartments, where the compartments are made of film having different solubilities (as taught in WO 02/08380).

### EXAMPLES

Abbreviations used in Examples

In the examples, the abbreviated component identifications have the following meanings:
Laponite® Laponite® RD synthetic hectorite available from Rockwood Additives Limited.
Carbonate Anhydrous sodium carbonate.
KOH Potassium hydroxide.
Percarbonate Sodium percarbonate
PA30 Polyacrylic acid available from BASF.
CP5 Copolymer acrylic maleic available from BASF.
GLDA Chelant, Disolvine GL (tetrasodim N,N-bis(carboxylato methyl-L-glutamate) from Azko Nobel.
Natalase Amylase from Novozymes.
FN3 Protease from Genecor.

In the following examples all levels are quoted as parts by weight of the composition.

Example 1 and 2 illustrate the use of compositions comprising an exfoliable clay, Laponite®, for the removal of different types of soil in a dishwasher. The dishwasher load comprises different soils and different substrates: Macaroni & Cheese on stainless steel baked for 7 minutes at 200° C., scrambled eggs on ceramic bowls microwaved for 2 minutes, cooked rice on ceramic dishes, scrambled eggs on stainless steel slides and cooked pasta on glass slides. The dishware is allowed to dry for 12 hours and then is ready to use. The dishware is loaded in a dishwasher (i.e GE Model GSD4000, Normal Wash at 50° C.).

The cleaning solutions are prepared by pre-dissolving the ingredients in 250 ml water in the following order: deionised water, alkalinity source, Laponite®, polymers and chelant. After that, the solutions are sonicated for 10 minutes and left stand for 12 hours before using.

The cleaning was excellent in all cases and especially in the case of starch based soils.

EXAMPLE 1

| | |
|---|---|
| Laponite | 11.0 |
| PA30 | 16.6 |
| CP5 | 16.6 |
| Natalase | 0.9 |
| FN3 | 1.3 |
| Percarbonate | 12.1 |
| Na₂CO₃ | 41.4 |
| | 100.0 |

EXAMPLE 2

| | |
|---|---|
| Laponite | 20.0 |
| PA30 | 12.0 |
| GLDA | 32.0 |
| Natalase | 0.8 |
| FN3 | 1.6 |
| Percarbonate | 17.6 |
| KOH | 16.0 |
| | 100.0 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A method of cleaning a soiled load in an automatic dishwasher comprising the step of contacting the load with a phosphate free wash liquor comprising exfoliated nanoclay and the wash liquor having a pH of from about 9 to about 12 and an ionic strength of from about 0.001 to about 0.02 moles/l.

2. A method according to claim 1 wherein the wash liquor comprises from about 100 ppm to about 2,500 ppm of nanoclay.

3. A method according to claim 1 wherein the wash liquor comprises from about 20 to about 1,200 ppm of an alkalinity

4. A method according to claim 3, wherein said alkalinity source comprises a source of univalent ions.

5. A method according to claim 1 wherein the wash liquor comprises a nanoclay dispersant.

6. A method according to claim 5, wherein said dispersant is present in concentration of from about 200 ppm to about 2,500 ppm by weight of the wash liquor.

7. A method according to claim 6 wherein the nanoclay dispersant is selected from the group consisting of dispersant polymer, chelant and mixtures thereof.

8. A method according to claim 7 wherein the nanoclay dispersant comprises a dispersant polymer.

9. A method according to claim 8, wherein said polymer is a polyacrylate homopolymer having a molecular weight of from about 1,000 to about 30,000.

10. A method according to claim 1 wherein the wash liquor comprises from about 200 to about 500 ppm of exfoliated nanoclay and from about 0.01 to about 20 ppm of active enzyme.

11. A method according to claim 10 wherein the nanoclay and enzyme are sequentially delivered with respect to one another to the wash liquor.

12. A composition for use in a method according to claim 1 comprising from about 5 to about 60% by weight of the composition of nanoclay.

13. A composition according to claim 12 comprising from about 1 to about 40% by weight of the composition of an alkalinity source, wherein the alkalinity source comprises a source of univalent ions.

14. A composition according to claim 12 comprising from about 10 to about 60% by weight of the composition of a nanoclay dispersant.

15. A composition according to claim 12 wherein the composition is in solid form.

16. A water-soluble pouch comprising a composition according to claim 12.

17. A method of removing starch based soils from dishware/tableware in an automatic dishwasher comprising the step of contacting the dishware/tableware with a wash liquor comprising a composition according to claim 12.
